(19) United States
(12) Patent Application Publication
(10) Pub. No.: US 2016/0148324 A1
(43) Pub. Date: May 26, 2016

(54) SYSTEM FOR PROMOTING AND DISTRIBUING USER-GENERATED CONTENT FOR ARTISTS TO RETAIN 100% OF THE REVENUE FROM SALES OF CONTENT

(71) Applicant: Anthony PEREZ, New York, NY (US)

(72) Inventor: Anthony PEREZ, New York, NY (US)

(21) Appl. No.: 14/552,737

(22) Filed: Nov. 25, 2014

(51) Int. Cl. G06Q 50/00; G06Q 30/02; H04L 29/08

(52) U.S. Cl. CPC G06Q 50/01; H04L 67/02; G06Q 30/0231

(57) ABSTRACT

A system embodying a method of organizing artists in a supportive network to facilitate the promotion of the artists' creative works and the retention of revenue of the sale of said creative works is provided. The system may provide an online platform providing a social network comprising a plurality of user-artists accounts each comprising at least one upload, each corresponding to a creative work, wherein the social network is configured so that user-artists engage in supportive activities so as to promote said creative work. The online platform may provide a predetermined amount of supportive credit to each user-artist to download desired uploads from a second user-artist account. The online platform may also provide a rating system to determine a supportive value of the use of the supportive credit used and the supportive activities by each user-artist, wherein the online platform rewards supportive points to at least one user-artist based at least in part on a determined supportive value. The online platform also allows non-user artists to purchase the promoted uploads whereby 100 percent of the revenue of sales of the at least one upload is retained by each associated user-artist account.

### BACKGROUND OF THE INVENTION

The present invention relates to systems for distributing and promoting user-generated content and, more particularly, to an online system for organizing artists in a supporting network so as to promote and distribute their creative work.

Currently, online distributors do not offer an affordable way for smaller recording artists to promote their artistic content, network with otherwise support other artists.

Historically, smaller music recording artists only receive from 15% to 35% financial compensation for their creative work from a record label or other third-party distributors. From that compensation, the artist has to either spend monies for self-promotion or pay other parties to provide the promotional services. What little is left is barely enough for the artist to make a living. Only larger well-known artist are able to financially excel past that point.

Although more-recent third party online distributors (e.g. iTunes, Spotify, Amazon) may claim artists retain all of the revenue from their digitally distributed content, such distributors have distribution-related fees that significantly erode the financial compensation for the artists' creative work.

As can be seen, there is a need for an online system for organizing artists in a supportive online network for promoting and distributing their creative work.

### SUMMARY OF THE INVENTION

In one aspect of the present invention, a system for incentivizing supporting activities on a social network, comprises a computer having a user interface; and a program product comprising machine-readable program code for causing, when executed, the computer to perform the following process steps: producing an electronic representation of a social network comprising a plurality of user-artists accounts each comprising at least one upload corresponding to an associated creative work, wherein the social network is configured so that user-artists engage in supportive activities; providing a predetermined amount of supportive credit to each user-artist account on a predetermined time basis, wherein the supportive credit is used to download the at least one upload from a second user-artist account; providing a rating system to determine a supportive value of the use of the supportive credit used and the supportive activities by each user-artist account over the predetermined time basis; receiving the supportive value for each user-artist account; and rewarding supportive points to at least one user-artist account based at least in part on the supportive value, thereby facilitating promotion among the plurality of user-artist accounts, and whereby 100 percent of the revenue of sales of the at least one upload is retained by each associated user-artist account.

In another aspect of the present invention, the above mentioned system further comprises social activity that comprises at least one of sending invitations to prospective users-artists, uploading at least one upload, downloading at least one upload, attend other user-artist events, and establishing a networking page; and further providing associating each user-artist account with one identifiable code upon completion of a registration process, and wherein the supportive activity comprises facilitating the association of new identifiable codes to prospective user-artists; and further providing a commission the each user-artist account at least in part on the new identifiable codes they facilitated over the predetermined time basis; and wherein the support points are redeemable for at least one of participation in promotional events, royalties, and commissions.

These and other features, aspects and advantages of the present invention will become better understood with reference to the following drawings, description and claims.

### BRIEF DESCRIPTION OF THE DRAWINGS

FIG. 1 is a block diagram of an exemplary embodiment of the present invention;

FIG. 2 is an exemplary embodiment of an electronic representation on a user interface of the present invention;

FIG. 3 is an exemplary embodiment of the electronic representation on the user interface of the present invention;

FIG. 4 is an exemplary embodiment of the electronic representation on a user interface of the present invention; and

FIG. 5 is an exemplary embodiment of the electronic representation on a user interface of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system embodying a method of organizing artists in a supportive network to facilitate the promotion of the artists' creative works and the retention of revenue of the sale of said creative works. The system may provide an online platform providing a social network comprising a plurality of user-artists accounts each comprising at least one upload, each corresponding to a creative work, wherein the social network is configured so that user-artists engage in supportive activities so as to promote said creative work. The online platform may provide a predetermined amount of supportive credit to each user-artist to download desired uploads from a second user-artist account. The online platform may also provide a rating system to determine a supportive value of the use of the supportive credit used and the supportive activities by each user-artist, wherein the online platform rewards supportive points to at least one user-artist based at least in part on a determined supportive value. The online platform also allows non-user artists to purchase the promoted uploads whereby 100 percent of the revenue of sales of the at least one upload is retained by each associated user-artist account.

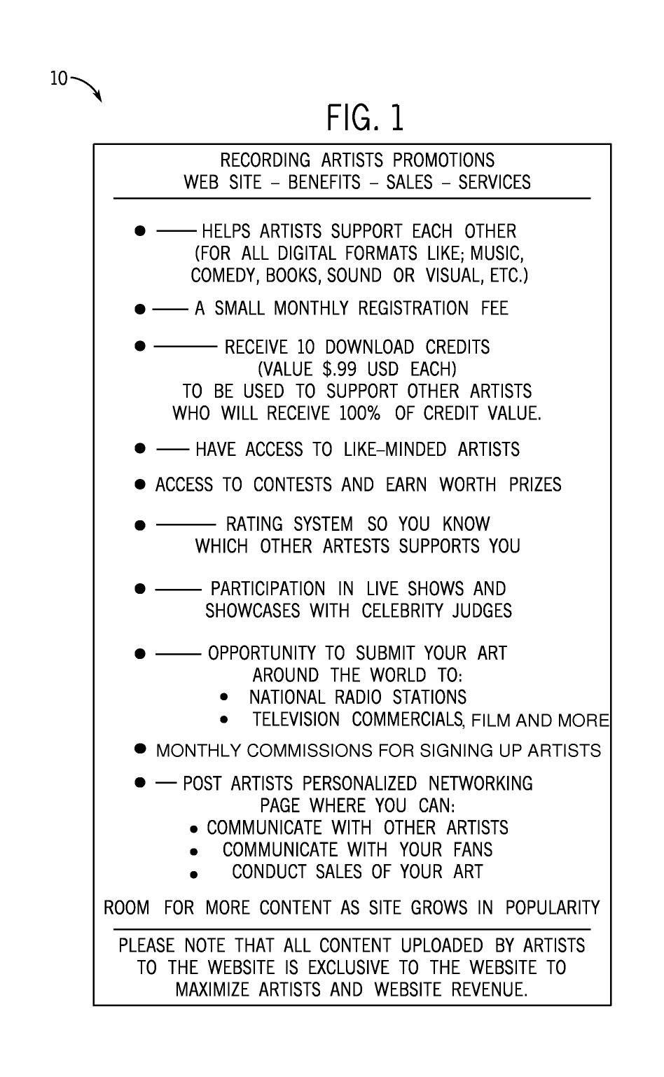

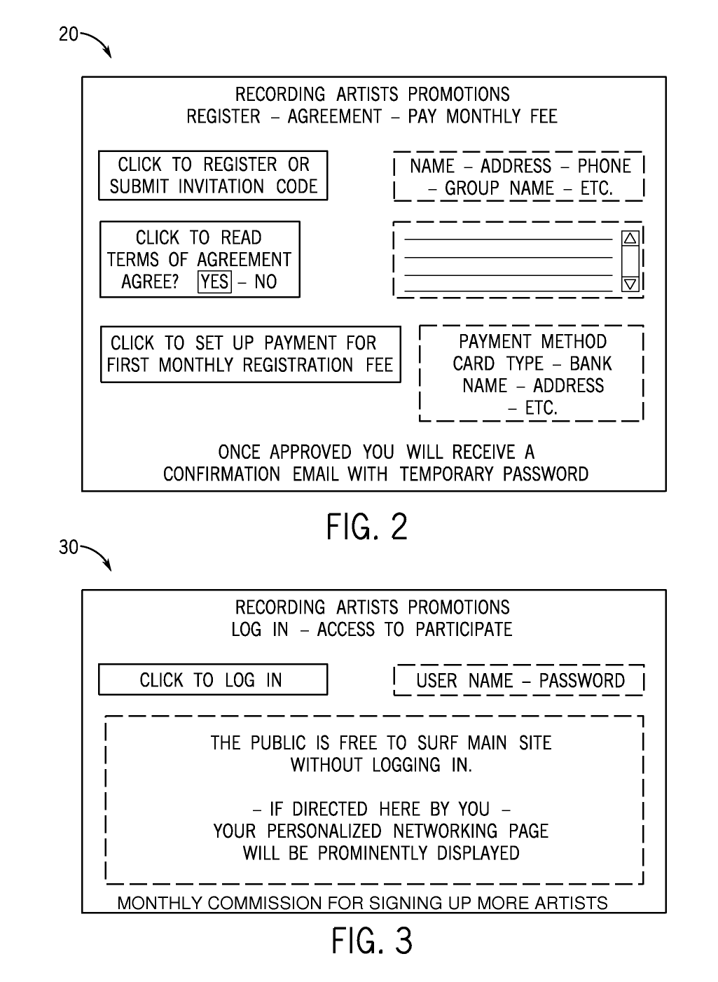

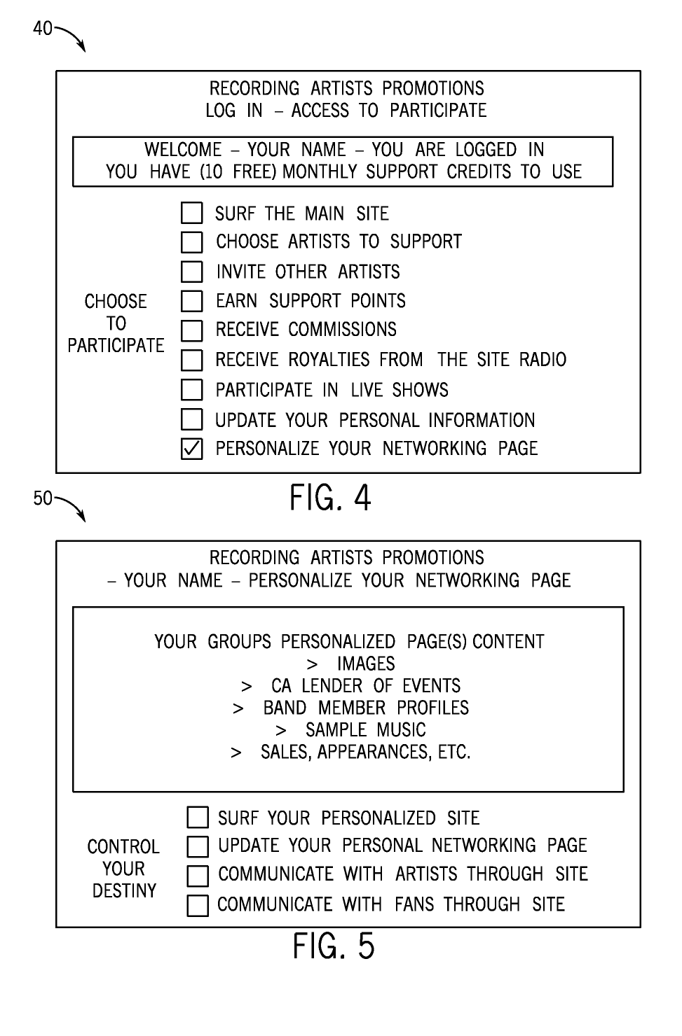

Referring to FIGS. 1 through 5, the present invention may provide an online platform 10 may form a supportive network of like-mined artists. The online platform 10 may include at least one computer with a user interface. The computer may include any computer having at least one processor and a form of memory including, but not limited to, a desktop, laptop, and smart device, such as, a tablet and smart phone. The computer may include a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The online platform 10 may include the functionality and provisions of typical social networking services, such as establishing a user-artist account, personalizing a networking page, viewing and communicating with the networking pages of other users and the like, as well as a novel registration process. Each registration process may include a predetermined registration fee, a predetermined number of uploaded creative works, a predetermined amount of supportive credit, an identifiable code, and the like.

The registration fee may be due over a predetermined time basis, such as monthly, yearly, quarterly or the like. There may be a sliding scale relative to the amount of the predetermined fees and the other above-mentioned features of the registration process.

And association is formed between each user-artist of the online platform 10 and one identifiable code. Each identifiable code may be created upon registration and payment of the registration fee. Each identifiable code may be associated with all transactions made by the associated user-artist, including sending invitations to prospective users-artists of the online platform 10, uploading creative works, downloading creative works, logging on, establishing the networking page, and the like.

The uploaded creative works may be the amount of content that a user-artist may upload onto the online platform over the predetermined time basis.

The supportive credit may include credit to download uploaded creative work associated with other user-artists—in other words creative works associated with a different identifiable code than that of the creditor, thereby supporting other user-artists' creative output on the online platform 10.

The online platform 10 may be configured to facilitate the purchase and promotion of the uploaded creative works of each user-artist. At 40, the user may search the platform 10, choose artists to support, invite other artists, earn support points, receive commissions, receive royalties, participate in event promoted or produced by the platform 10, update personal information, personalize the associated networking page.

The commissions may provide user-artist compensation for each new user-artist an existing user-artist gets to join the online platform 10. The online platform 10 may credit the commission for every new identifiable code the existing user-artist registers/creates on the online platform 10 over the predetermined time basis. The commission may be supportive credit, electronic payments or the like.

The online platform 10 may provide a rating system. The rating system may be configured to determine a plurality of supporting points for each user. Each user can earn supporting points by supporting other artists by, for example, downloading another user-artist's song, whereby the user-artist gets a predetermined number of support points. Similarly, for showing up to other user-artists events the artists may earn a predetermined amount of support points. Likewise, for commenting on the networking page of other artists, the artists may earn a predetermined amount of support points.

The rating system may be configured to facilitating the creation of a support mentality by enabling the conversion of earned supporting points into a plurality of incentivized activities. The plurality of incentivized activities may include monthly contests or cash giveaways based on the rank of supporting points earned over the predetermined time basis. The support mentality rewards the user-artists that show support to other user-artists on the platform 10, thereby facilitating a supportive network of user-artists that generates sales their creative works.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for incentivizing supporting activities on a social network, comprising:
a computer having a user interface; and
a program product comprising machine-readable program code for causing, when executed, the computer to perform the following process steps:
producing an electronic representation of a social network comprising a plurality of user-artists accounts each comprising at least one upload corresponding to an associated creative work, wherein the social network is configured so that user-artists engage in supportive activities;
providing a predetermined amount of supportive credit to each user-artist account on a predetermined time basis, wherein the supportive credit is used to download the at least one upload from a second user-artist account;
providing a rating system to determine a supportive value of the use of the supportive credit used and the supportive activities by each user-artist account over the predetermined time basis;
receiving the supportive value for each user-artist account; and
rewarding supportive points to at least one user-artist account based at least in part on the supportive value,
thereby facilitating promotion among the plurality of user-artist accounts, and whereby 100 percent of the revenue of sales of the at least one upload is retained by each associated user-artist account.

2. The system of claim 1, wherein the social activity comprises at least one of sending invitations to prospective users-artists, uploading at least one upload, downloading at least one upload, attend other user-artist events, and establishing a networking page.

3. The system of claim 2, further providing associating each user-artist account with one identifiable code upon completion of a registration process, and wherein the supportive activity comprises facilitating the association of new identifiable codes to prospective user-artists.

4. The system of claim 3, further providing a commission the each user-artist account at least in part on the new identifiable codes they facilitated over the predetermined time basis.

5. The system of claim 1, wherein the support points are redeemable for at least one of participation in promotional events, royalties, and commissions.
